(19) United States
(12) Patent Application Publication
(10) Pub. No.: US 2008/0172655 A1
(43) Pub. Date: Jul. 17, 2008

(54) Saving Code Coverage Data for Analysis

(75) Inventor: Brian D. Davia, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,156

(22) Filed: Jan. 15, 2007

(51) Int. Cl. G06F 9/44

(52) U.S. Cl. 717/130

(57) ABSTRACT

A plurality of different test cases may be run. Next, in response to running the plurality of different test cases, a plurality of traces may be received. Each of the plurality of traces may respectively correspond to a plurality of outputs respectively produced by each of the plurality of different test cases. Then, the plurality of traces may be saved in a database. Each of the saved plurality of tracts may respectively have a unique trace ID. The trace ID for each the plurality of traces may comprise a test case ID and a run ID. Next, an input may be received comprising the test case ID and the run ID. Then, based on the received input, the database may be queried for a first trace within the plurality of traces. The first trace may correspond to the input. Next the first trace may he transmitted to a requestor.

### RELATED APPLICATIONS

Related U.S. patent applications Ser. No. ______, entitled “Applying Function Level Ownership to Test Metrics,” Ser. No. ______, entitled “Collecting and Reporting Code Coverage Data,” and Ser. No. ______, entitled “Identifying Redundant Test Cases,” each assigned to the assignee of the present application and filed on even date herewith, are hereby incorporated by reference.

### BACKGROUND

When developing software, programming modules may be tested during the development process. Such testing may produce code coverage data. Code coverage data may comprise metrics that may indicate what code lines within a tested programming module have been executed during the programming module's test. The code coverage data may be useful in a number of ways, for example, for prioritizing mete testing efforts.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Code coverage date may be provided. First a plurality of different test cases may be run. Next, in response to running the plurality of different test cases, a plurality of traces may be received. Each of the plurality of traces may respectively correspond to a plurality of outputs respectively produced by each of the plurality of different test cases. Then, the plurality of traces may be saved in a database. Each of the saved plurality of traces may respectively have a unique trace ID. The trace ID for each the plurality of traces may comprise a test case ID and a run ID. Next, an input may be received, comprising the test cast ID and the run ID. Then, based on the received input, the database may be queried for a first trace (or set of traces) within the plurality of traces. The first trace may correspond to the input. Next, code coverage summary data representing the first trace may be transmitted to a requestor.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various, embodiments of the present invention in the drawings:

FIG. 1 is a block diagram of an operating environment;

FIG. 2 is a flow chart of a method for providing code coverage data; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and ether implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A software testing tool may be used by a computer program tester to collect code coverage data. The code coverage data may allow the tester to see which code pieces (e.g. code lines) are executed while testing a software program. The testers may use the software testing tool to collect code coverage data during an automation run (e.g. executing a ply ratify of test cases) to see, for example, which code lines in the software program were executed by which test cases during the automation run.

A test case may be configured to test aspects of the software program. To do so, the test case may operate on a binary executable version of the software program populated with coverage code. For example, the test case may be configured to cause the binary executable version to open a file. Consequently, the coverage code along with code coverage tools in the binary executable version may be configured to produce the code coverage data configured to indicate what code within the binary executable version was used during the test. In this test example, the coverage code may produce the code coverage data indicating what code within the binary executable version was executed during the file opening test case.

A trace may comprise a code coverage unit data collected from a test case run. The trace may comprise code blocks executed from the beginning to the end of the test case. For example, the tester may collect one trace for each test case run. On occasion, it may be useful to dig deeper to see exactly which code blocks (or even code lines) art executed by a particular test case or a set of test cases. Conventional systems, however, save traces under a test case name that generated the trace. Because a test case could be executed more than once targeting different platforms, or languages, for example, saving traces by a test case name my not be useful in some situations.

Consistent with embodiments of the invention, a unique trace ID may be generated for each test case instance and used to name the trace created. This unique trace ID may comprise a test case ID and a run ID that can map back to the trace ID created by a test case during a run. In other words, code coverage data may be saved with an ID that can be mapped back to the particular test case instance (e.g. execution) that generated the corresponding code coverage data. Given a run ID and test case ID, for example, code coverage data may be mapped to an instance under which the coverage data was generated and saved.

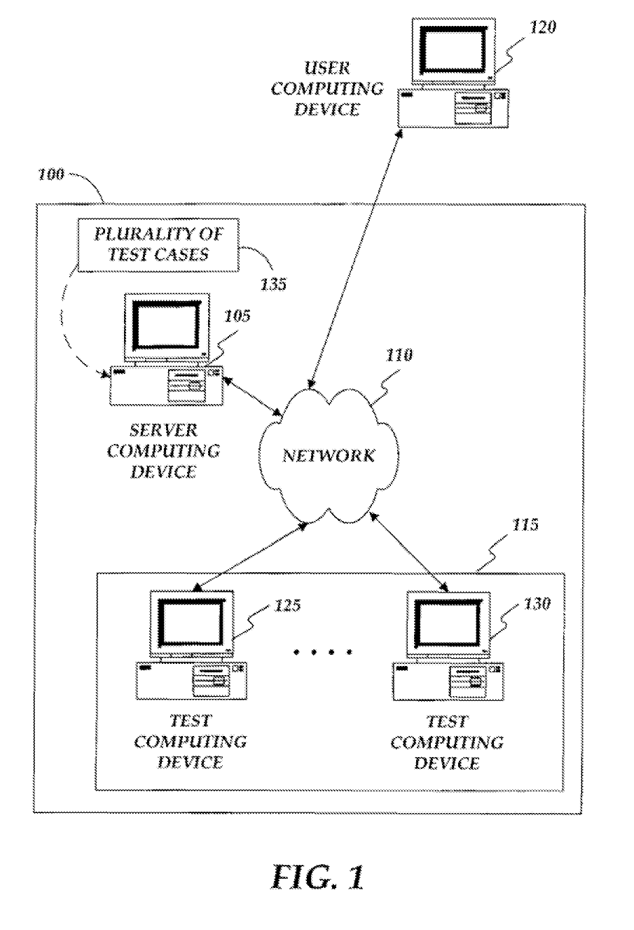

FIG. 1 is a block diagram of an automation testing system 100 consistent with an embodiment of the inversion. System 100 may include a server computing device 105, a network 110, and a plurality of test computing devices 115. Server computing device 105 may communicate with a user computing device 120 over network 110. Plurality of test computing devices 115 may include, but is not limited to, test computing devices 125 and 130. In addition, plurality of test computing devices 115 may comprise a plurality of test computing devices in, for example, a test laboratory controlled by server computing device 105. Plurality of test computing devices 115 may each have different microprocessor models and/or different processing speeds. Furthermore, plurality of test computing devices 115 may each have different operating systems and hardware components.

Consistent with embodiments of the invention, code coverage data may be collected using system 100. System 100 may perform a run or series of runs. A run may comprise executing one or more test cases (e.g. a plurality of test cases 135) targeting a single configuration. A configuration may comprise a state of the plurality of test computing devices 115 including hardware, architecture, locale, and operating system. A suite may comprise a collection of runs. System 100 may collect code coverage data (e.g. traces) resulting from running the test cases. As described above and as described in more detail below, each trace may be tagged and saved in a database with a trace ID. Latter, the database may be queried on the trace ID.

Network 110 may comprise, for example, a local area network (LAN) or a wide area network (WAN). Such networking environments are commonplace in offices, enterprise-wide computer networks, intranets, and the Internet. When a LAN is used as network 110, a network interface located at any of the computing devices may be used to interconnect any of the computing devices. When network 110 is implemented in a WAN networking environment, such as the Internet, the computing devices may typically include an internal or external modem (not shown) or other means for establishing communications over the WAN. Further, in utilizing network 110, data sent over network 110 may be encrypted to insure data security by using encryption/decryption techniques.

In addition to utilizing a wire line communications system as network 110, a wireless communicates system, or a combination of wire line and wireless may be utilized as network 110 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The computing devices in the wireless environment can be any mobile terminal, such as the mobile terminals described above. Wireless data may include, but is not limited to, paging, text messaging, e-mail, Internet access and other specialized data applications specifically excluding or including voice transmission. For example, the computing devices may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

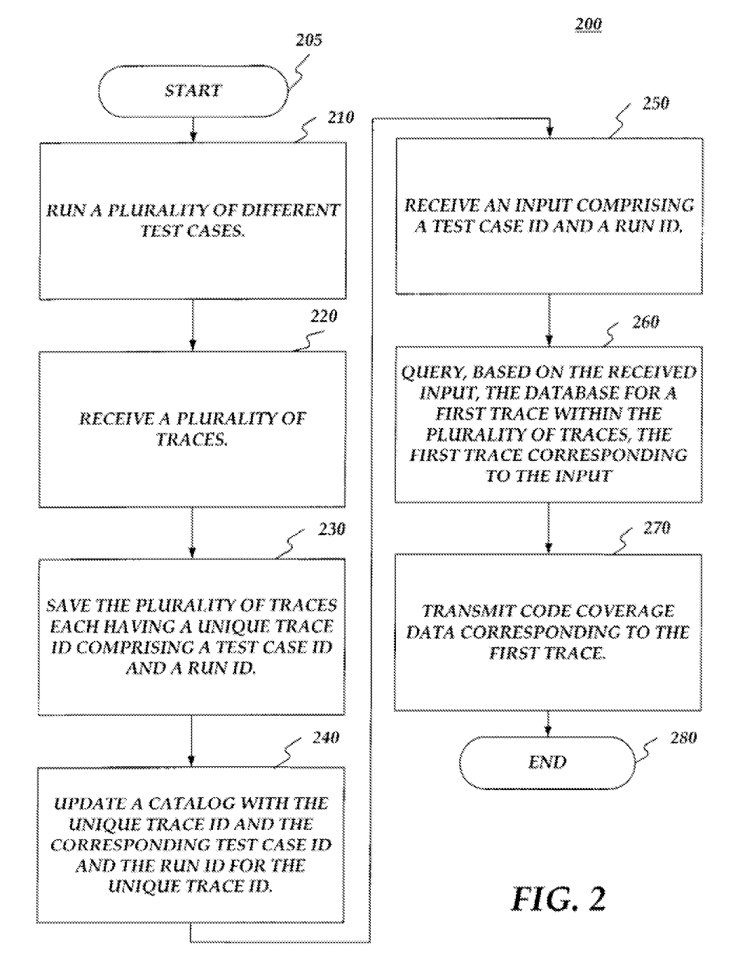

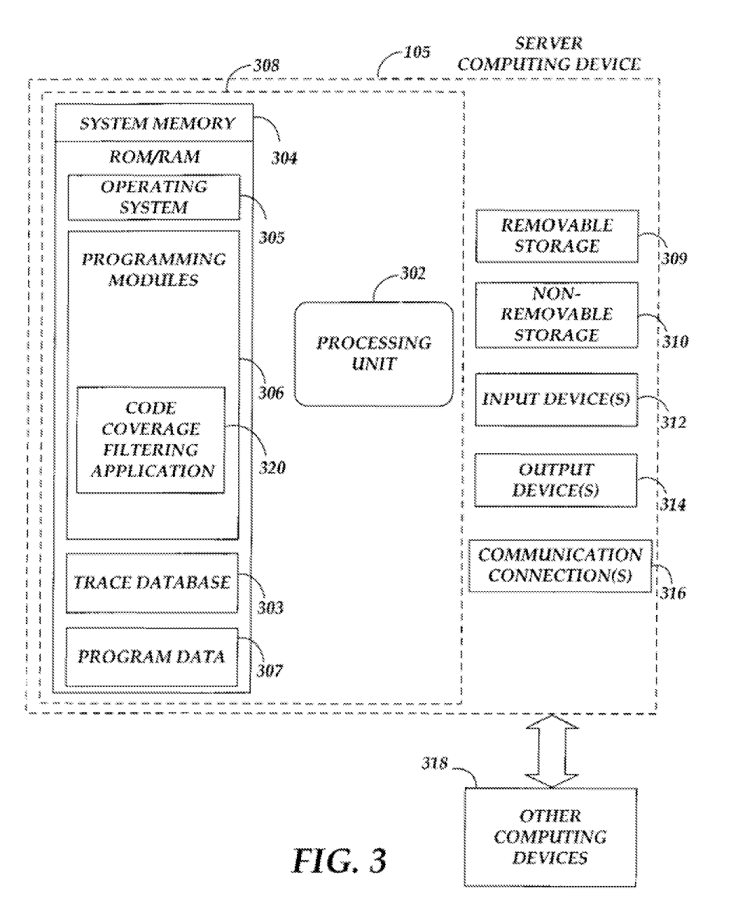

FIG. 2 is a flow chart setting forth the general stages involved in a method 200 consistent with an embodiment of the invention for providing code coverage data. Method 200 may be implemented using computing device 105 as described above and in more detail below with respect to FIG. 3. Ways to implement the stages of method 200 will be described in greater detail below. Method 200 may begin at starting block 205 and proceed to stage 210 where computing device 115 may run a plurality of different test cases 135. For example, a software developer may wish to test a software program. When developing software, software programs may be tested during the development process. Such testing may produce code coverage data. Code coverage data may comprise metrics that may indicate what code pieces within a tested software program have been executed during the software program's test.

Each one of plurality of different test cases 135 may be configured to test a different aspect of the software program. To do so, plurality of test cases 135 may operate on a binary executable version of the software program populated with coverage code. For example, one of plurality of test cases 135 may be configured to cause the binary executable version to open a file, while another one of plurality of test cases 135 may cause the binary executable version to perform another operation. Consequently, the coverage code in the binary executable version may be configured to produce the code coverage data configured to indicate what code within the binary executable version was used during the test. In this test example, the coverage code may produce the code coverage data indicating what code within the binary executable version was executed during the file opening test.

Plurality of test computing devices 115 may comprise a plurality of test computing devices in, for example, a test laboratory controlled by server computing device 105. To run plurality of test cases 135, server computing device 105 may transmit, over network 110, plurality of test cases 135 to plurality of test computing devices 115. Server computing device 105 may oversee running plurality of test oases 135 on plurality of test computing devices 115 over network 110. Before running plurality of test cases 135, plurality of test computing devices 115 may he setup in a single configuration. A configuration may comprise the state of plurality of test computing devices 115 including hardware, architecture, locale, and operating system. Locale may comprise a language in which the software program is to user interface. For example, plurality of test computing devices 115 may be setup in a configuration to test a word processing software program that is configured to interface with users in Arabic. Arabic is an example and any language may be used.

From stage 210, where computing device 105 runs the plurality of test cases 135, method 200 may advance to stage 220 where computing device 105 may receive, in response to running plurality of test cases 135, a plurality of traces. Each of the plurality of traces may respectively correspond to a plurality of outputs respectively produced by each of plurality of test cases 135. For example, a trace may comprise a unit of code coverage data collected from a test case run. A trace may comprise code blocks executed from the beginning to the end of the test case. For example, the tester may collect one trace for each test case run. In the above file opening example, the trace returned from such a test case may indicate all lines of code in the software program that were executed by the software program by the file open test case.

Plurality of test cases 135 running on plurality of test computing devices 115 may respectively produce the plurality of traces. For example, a first line of code corresponding to the software program may be executed by a first test case within plurality of different test cases 135 and the same first line of code may be executed by a second test ease within plurality of different test cases 135. Corresponding traces produced by the first and second test cases may indicate that both test cases covered the same code line. Once plurality of test computing devices 115 produce the plurality of traces, plurality of test computing devices 115 may transmit the plurality of traces to server computing device 105 over network 110.

Once computing device 105 receives the plurality of traces in stage 220, method 200 may continue to stage 230 where computing device 105 may save the plurality of traces in a trace database 303 as described below with respect to FIG. 3. Each of the saved plurality of traces may respectively have a unique trace ID. The trace ID for each of the plurality of traces may comprise a test case ID and a run ID. For example, the test case ID may comprise an identifier unique to each one of the corresponding plurality of test cases 135 that produced the corresponding trace. In other words, each one of the plurality of traces may have a its own unique test case ID that maps back to the one of plurality of test cases 135 that produced the trace. Furthermore, the test case ID may be configured to indicate an aspect of the software program a respective one of the corresponding plurality of test cases 135 is configured to test. For example, if the trace was produced from a test case configured to test file opening, the test case ID may indicate this.

Furthermore, the run ID may comprise an identifier unique to running plurality of different test cases 135. For example, the run ID may comprise an identifier indicating when running plurality of different test cases 135 occurred, hardware on which running plurality of test cases 135 occurred, and an operating system on which running plurality of test cases 135 occurred. Moreover, the run ID may comprise an identifier indicating a locale corresponding to the software program tested by running plurality of test cases 135. As stated above, the locale may indicate a language in which the software program is to user interface. In other words, the run ID may indicate how plurality of test computing devices 115 were configured while running plurality of test cases 135, when plurality of test cases 135 were run, where plurality of teat cases 135 were run, a version of the tested software program, or other aspects of the tested software program such as locale.

After computing device 105 saves the plurality of traces in stage 230, method 200 may proceed to stage 240 where computing device 105 may update a catalog with the unique trace ID and the corresponding test case ID and the run ID for the unique trace ID. For example, a catalogue database may be kept on server computing device 105. As such, a tester using user computer device 120 may check the catalog database for all instances in which a particular test case was run. For example, the tester may be responsible for the aforementioned file open test case. Consequently, the tester may query the catalog database for all instances in which the file open test case was run. And from this, the tester can obtain all trace IDs for all instances for this particular test for which the tester is responsible. After reviewing the catalog, the user may note one trace ID corresponding to a particular instance for which the tester is interested in obtaining a trace.

From stage 240, where computing device 105 updates the catalog, method 200 may advance to stage 250 where computing device 105 may receive an input comprising the test case ID and the run ID. For example, after the tester obtains the trace ID corresponding to a test in which the tester is interested as described above, the tester, using user computing device 120, may transmit the corresponding particular trace ID to server computing device 105 over network 110.

Once computing device 105 receives the input (e.g. a particular trace ID) in stage 250, method 200 may continue to stage 260 where computing device 105 may query, based on the received input, trace database 303 for a first trace within the plurality of traces. The first trace may correspond to the input. For example, the first trace may comprise the trace for which the tester is interested as described above with respect to stage 240.

After computing device 105 queries trace database 303 in stage 260, method 200 may proceed to stage 270 where computing device 105 may transmit the first trace. For example, server computing device 105 may transmit the first trace over network 110 to the tester at user computing device 120. Similarly, the same can be done for a set of traces. Once server computing device 105 transmits the first trace in stage 270, method 200 may then end at stage 280.

An embodiment consistent with the invention may comprise a system for providing code coverage data. The system may comprise a memory storage and a processing unit coupled to the memory storage. The processing unit may be operative to run a plurality of different test cases and to receive, in response to running the plurality of different test cases, a plurality of traces. Each of the plurality of traces may respectively correspond to a plurality of outputs respectively produced by each of the plurality of different test cases. In addition, the processing unit may be operative to save the plurality of traces in a database. Each of the saved plurality of traces may respectively have a unique trace ID. The trace ID for each the plurality of traces may comprise a test case ID and a run ID.

Another embodiment consistent with the invention may comprise a system for providing code coverage data. The system may comprise a memory storage and a processing unit coupled to the memory storage. The processing unit may be operative to receive an input comprising a test case ID and a run ID. In addition, the processing unit may be operative to query, based on the received input, a database for a first trace corresponding to the input. The database may comprise a plurality of traces. Each of the plurality of traces may respectively correspond to a plurality of outputs respectively produced by each of a plurality of different test cases configured to test a software program. Furthermore, the processing unit may be operative to transmit the first trace.

Yet another embodiment consistent with the invention may comprise a system for providing code coverage data. The system may comprise a memory storage and a processing unit coupled to the memory storage. The processing unit may be operative to receive, in response to running a plurality of different test cases on a plurality of testing computers, a plurality of traces. Each of the plurality of traces may respectively correspond to a plurality of outputs respectively produced by each of the plurality of different test cases. In addition, the processing unit may be operative to save the plurality of traces in a database. Each of the saved plurality of traces may respectively have a unique trace ID. The trace ID for each the plurality of traces may comprise a test case ID and a run ID.

FIG. 3 is a block diagram of a system including computing device 105. Consistent with an embodiment of the invention, the aforementioned memory storage and processing unit may be implemented in a computing device, such as computing device 105 of FIG. 3. Any suitable combination of hardware, software, or firmware may be used to implement the memory storage and processing unit. For example, the memory storage and processing unit may be implemented with computing device 105 or any of other computing devices 318, in combination with computing device 105. The aforementioned system, device, and processors are examples and other systems, devices, and processors may comprise the aforementioned memory storage and processing unit, consistent with embodiments of the invention.

With reference to FIG. 3, a system consistent with an embodiment of the invention may include a computing device, such as computing device 105. In a basic configuration, computing device 105 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, trace database 303 (as described above) and may include a program data 307. System memory 304 may also include trace database 303 in which server computing device 105 may save the plurality of traces. Operating system 305, for example, may be suitable for controlling computing device 300's operation. In one embodiment, programming modules 306 may include a code coverage filtering application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 105 may have additional features or functionality. For example, computing device 105 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 105. Any such computer storage media may be part of device 105. Computing device 105 may also have input device(s) 312 such as a keyboard, a mouse, a pen, a sound input device, a touch input device, etc. Output device(s) 314 such as a display, speakers, a printer, etc, may also be included. The aforementioned devices are examples and others may be used.

Computing device 105 may also contain a communication connection 316 that may allow device 105 to communicate with other computing devices 318, such as over a network (e.g. network 110) in a distributed computing environment, for example, an intranet or the Internet. As described above, other computing devices 318 may include plurality of test computing devices 115. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. code coverage filtering application 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specie computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program, can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing code coverage data, the method comprising:
running a plurality of different test cases;
receiving, in response to running the plurality of different test cases, a plurality of traces, each of the plurality of traces respectively corresponding to a plurality of outputs respectively produced by each of the plurality of different test cases; and
saving the plurality of traces in a database, each of the saved plurality of traces respectively having a unique trace ID, the trace ID for each the plurality of traces comprising a test case ID and a run ID.

2. The method of claim 1, wherein running the plurality of different test cases comprises running the plurality of different test cases wherein each of the plurality of different test cases is respectively configured to test a different aspect of a software program.

3. The method of claim 1, wherein receiving the plurality of traces comprises receiving the plurality of traces wherein the plurality of traces each respectively indicates code lines corresponding to a software program that were executed as a result of running the plurality of different test cases.

4. The method of claim 1, wherein receiving the plurality of traces comprises receiving the plurality of traces wherein the plurality of traces each respectively indicates code lines corresponding to a software program that were executed as a result of running the plurality of different test cases wherein a first line of code corresponding to the software program was executed by a first test case within the plurality of different test cases and the first line of code corresponding to the software program was executed by a second test case within the plurality of different test cases.

5. The method of claim 1, wherein saving the plurality of traces in the database, each of the saved plurality of traces having the unique trace ID, the trace ID for each the plurality of traces comprising the test case ID and the run ID comprises saving the plurality of traces in the database, each of the saved plurality of traces having the unique trace ID, the trace ID for each the plurality of traces comprising the test case ID and the run ID wherein the test case ID comprises an identifier unique to each of the corresponding plurality of different test cases, the test case ID configured to indicate an aspect of a software program a respective one of the corresponding plurality of different test cases is configured to test.

6. The method of claim 1, wherein saving the plurality of traces in the database, each of the saved plurality of traces having the unique trace ID, the trace ID for each the plurality of traces comprising the test case ID and the run ID comprises saving the plurality of traces in the database, each of the saved plurality of traces having the unique trace ID, the trace ID for each the plurality of traces comprising the test case ID and the run ID wherein the run ID comprises an identifier unique to running the plurality of different test cases.

7. The method of claim 1, wherein saving the plurality of traces in the database, each of the saved plurality of traces having the unique trace ID, the trace ID for each the plurality of traces comprising the test case ID and the run ID comprises saving the plurality of traces in the database, each of the saved plurality of traces having the unique trace ID, the trace ID for each the plurality of traces comprising the test case ID and the run ID wherein the run ID comprises an identifier indicating at least one of the following: when running the plurality of different test cases occurred, hardware on which running the plurality of different test cases occurred, and an operating system on which running the plurality of different test cases occurred.

8. The method of claim 1, wherein saving the plurality of traces in the database, each of the saved plurality of traces having the unique trace ID, the trace ID for each the plurality of traces comprising the test case ID and the run ID comprises saving the plurality of traces in the database, each of the saved plurality of traces having the unique trace ID, the trace ID for each the plurality of traces comprising the test case ID and the run ID wherein the run ID comprises an identifier indicating a locale corresponding to a software program tested by running the plurality of different test cases, the locale indicating a language in which the software program is to user interface.

9. The method of claim 1, further comprising updating a catalog with the unique trace ID and the corresponding test case ID and the run ID for the unique trace ID.

10. The method of claim 1, further comprising:
receiving an input comprising the test case ID and the run ID;
querying, based on the received input, the database for a first trace within the plurality of traces, the first trace corresponding to the input; and
transmitting the first trace.

11. A computer-readable medium which stores a set of instructions which when executed performs a method for providing code coverage data, the method executed by the set of instructions comprising:
receiving an input comprising a test case ID and a run ID;
querying, based on the received input, a database for a first trace corresponding to the input, the database comprising a plurality of traces, each of the plurality of traces respectively corresponding to a plurality of outputs respectively produced by each of a plurality of different test cases configured to test a software program; and
transmitting code coverage data representing the first trace.

12. The computer-readable medium of claim 11, wherein receiving the input comprising the test case ID and the run ID comprises receiving the input comprising the test case ID and the run ID wherein the test case ID comprises an identifier unique to a first test case, within the plurality of different test cases, configured to indicate an aspect of a software program the first test case is configured to test.

13. The computer-readable medium of claim 11, wherein receiving the input comprising the test case ID and the run ID comprises receiving the input comprising the test case ID and the run ID wherein the run ID comprises an identifier unique to an event of running a first test case configured to indicate an aspect of a software program the first test case is configured to test.

14. The computer-readable medium of claim 11, wherein receiving the input comprising the test case ID and the run ID comprises receiving the input comprising the test case ID and the run ID wherein the run ID comprises an identifier indicating at least one of the following: when running a first test case configured to indicate an aspect of a software program the first test case is configured to test occurred, hardware on which running the first test case configured to indicate the aspect of a software program the first test case is configured to test occurred, and an operating system on which running the first test case configured to indicate the aspect of a software program the first test case is configured to test occurred.

15. The computer-readable medium of claim 11, wherein receiving the input comprising the test case ID and the run ID comprises receiving the input comprising the test case ID and the run ID wherein the run ID comprises an identifier indicating a local corresponding to a software program tested by running a first test case configured to indicate an aspect of the software program the first test case is configured to test, the local indicating a language in which the software program is to user interface.

16. A system for providing code coverage data, the system composing:
a memory storage; and
a processing unit coupled to the memory storage, wherein the processing unit is operative to:
receive, in response to running a plurality of different test cases on a plurality of testing computers, a plurality of traces, each of the plurality of traces respectively corresponding to a plurality of outputs respectively produced by each of the plurality of different test cases; and
save the plurality of traces in a database, each of the saved plurality of traces respectively having a unique trace ID, the trace ID for each the plurality of traces comprising a test case ID and a run ID.

17. The system of claim 16, wherein the processing unit being operative to receive, in response to running the plurality of different test cases on the plurality of testing computers, the plurality of traces further comprises the processing unit being operative to receive, in response to running the plurality of different test cases on the plurality of testing computers, the plurality of traces wherein each of the plurality of different test cases is respectively configured to test a different aspect of a software program.

18. The system of claim 16, wherein the processing unit being operative to receive comprises the processing unit being operative to receive wherein the plurality of traces each respectively indicates code lines corresponding to a software program that were executed as a result of the plurality of different test corresponding to the plurality of traces.

19. The system of claim 16, wherein the processing unit being operative to receive comprises the processing unit being operative to receive wherein a first line of code corresponding to the software program was executed by a first test case within the plurality of different test cases and the first line of code corresponding to the software program was executed by a second test case within the plurality of different test cases.

20. The system of claim 16, wherein the processing unit being operative to save the plurality of traces in the database comprises the processing unit being operative to save the plurality of traces in the database wherein the test case ID comprises an identifier unique to each of the corresponding plurality of different test cases configured to indicate an aspect of a software program a respective one of the corresponding plurality of different test cases is configured to test.
